(19) United States
(12) Patent Application Publication
(10) Pub. No.: US 2026/0185299 A1
(43) Pub. Date: Jul. 2, 2026

(54) DYE DISPERSION, METHOD FOR PREPARING THE SAME, AND DYEING METHOD

(71) Applicant: INDUSTRIAL TECHNOLOGY RESEARCH INSTITUTE, Hsinchu (TW)

(72) Inventors: Jie-Len HUANG, Hsinchu City (TW); Pei-Ching CHANG, Zhubei City (TW); Ya-Lin LIN, Hsinchu City (TW); Ke-Ming LIANG, Hsinchu City (TW); Yu-Chang CHUANG, Taoyuan City (TW); Chia-Chun CHEN, Hsinchu City (TW)

(73) Assignee: INDUSTRIAL TECHNOLOGY RESEARCH INSTITUTE, Hsinchu (TW)

(21) Appl. No.: 19/006,530

(22) Filed: Dec. 31, 2024

(51) Int. Cl. D06P 1/22; C09B 7/02; C09B 7/04; C09B 7/08; C09B 67/46; D06P 3/52

(52) U.S. Cl. CPC D06P 1/228; C09B 7/02; C09B 7/04; C09B 7/08; C09B 67/0084; D06P 3/52

(57) ABSTRACT

A dye dispersion, a method for preparing the same, and a dyeing method are provided. The dye dispersion includes a dye, a dispersant and water. The dye has a particle size distribution D90 of 1 nm to 2.5 μm, and the dye has a structure represented by Formula (I), Formula (II), or Formula

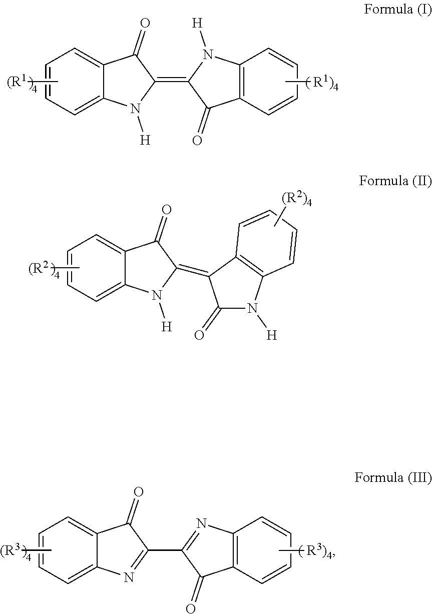

wherein R¹, R², and R³ are independently H, F, Cl, Br, or —SO₃Na.

### TECHNICAL FIELD

The disclosure relates to a dye dispersion, method for preparing the same, and dyeing method.

### BACKGROUND

Polyester fiber is a synthetic fiber widely used in daily life. It has applications in textile materials, home decoration, and furniture fillers. Due to its high hydrophobicity, polyester fiber is not easily dyed, and is mainly colored using disperse dyes. The chemical structure of disperse dyes is primarily based on azo- and anthraquinone-based compounds, with some heterocyclic disperse dyes also in use. However, conventional azo- or anthraquinone-based dyes are generally derived from petrochemical synthesis, and the use of many of their raw materials raise concerns regarding carcinogenicity and environmental hazards. In response to the global trend toward non-toxic and low-carbon manufacturing, the textile industry is shifting towards sustainable production, leading to significant restrictions on the future use of petrochemical dyes.

Indigo dye can be derived from plant extracts or produced through microbial processes, aligning with the textile industry's demand for sustainable dyes. Since indigo dye is poorly soluble in water, the dyeing process typically requires chemical agents and multiple dyeing steps, followed by oxidation to convert it into water-insoluble indigo that adheres to the fiber. However, the reduced water-soluble form of indigo dye has high alkalinity, which would damage fibers that are sensitive to alkaline conditions. Currently, there is no established dyeing process specifically designed for polyester fibers to enable the application of indigo dye.

Accordingly, there is a need in the industry for a novel indigo dye and dyeing method.

### SUMMARY

The disclosure provides a dye dispersion, a method for preparing the same, and dyeing method. According to embodiments of the disclosure, the dye dispersion includes a dye, a dispersant, and water. The dye has a particle size distribution D90 of 1 nm to 2.5 μm, and the dye has a structure represented by Formula (I), Formula (II), or Formula (III)

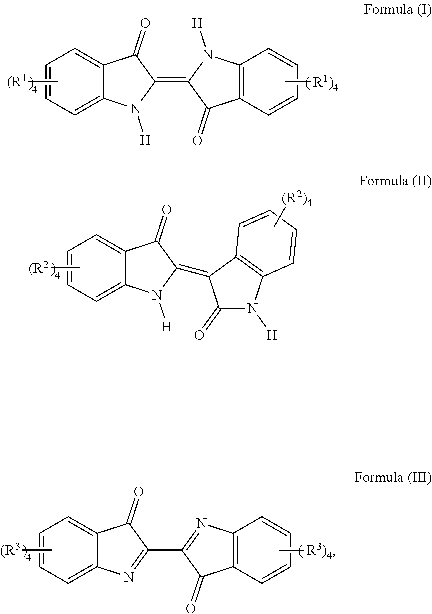

wherein R¹, R² and R³ are independently H, F, Cl, Br, or —SO₃N.

The disclosure provides a method for preparing dye dispersion including the following steps. A composition is provided, wherein the composition includes a dye, a dispersant and water; and, the composition is subjected to a homogenization treatment to obtain the aforementioned dye dispersion. The dye has a structure represented by Formula (I), Formula (II), or Formula (III)

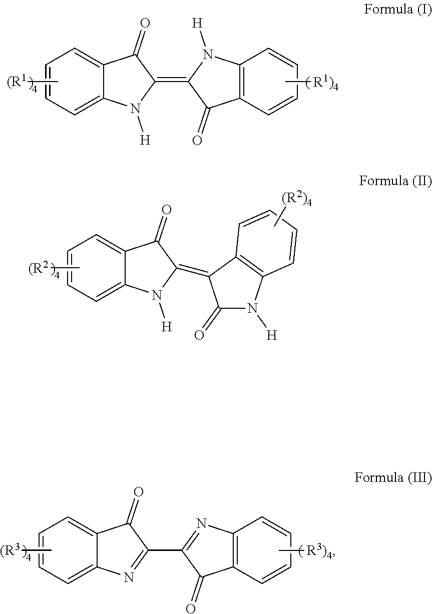

wherein R¹, R² and R³ are independently H, F, Cl, Br, or —SO₃Na.

The disclosure also provides a dyeing method including the following steps. A fabric is subjected to a dyeing process with a dye composition to obtain a colored fabric, wherein the dye composition includes the aforementioned dye dispersion.

A detailed description is given in the following embodiments.

### BRIEF DESCRIPTION OF THE DRAWINGS

The disclosure can be more fully understood by reading the subsequent detailed description and examples with references made to the accompanying drawings, wherein:

FIG. 1 is a flow chart illustrating the method for preparing dye dispersion according to embodiments of the disclosure.

FIG. 2 is a flow chart illustrating the dyeing method 100 according to embodiments of the disclosure.

### DETAILED DESCRIPTION

The dye dispersion, method for preparing the same, and dyeing method are described in detail in the following description. In the following detailed description, for purposes of explanation, numerous specific details and embodiments are set forth in order to provide a thorough understanding of the disclosure. The specific elements and configurations described in the following detailed description are set forth in order to clearly describe the disclosure. It will be apparent, however, that the exemplary embodiments set forth herein are used merely for the purpose of illustration, and the inventive concept may be embodied in various forms without being limited to those exemplary embodiments. In addition, the drawings of different embodiments may use like and/or corresponding numerals to denote like and/or corresponding elements in order to clearly describe the disclosure. However, the use of like and/or corresponding numerals in the drawings of different embodiments does not suggest any correlation between different embodiments. As used herein, the term “about” in quantitative terms refers to plus or minus an amount that is general and reasonable to persons skilled in the art.

Furthermore, the use of ordinal terms such as “first”, “second”, “third”, etc., in the disclosure to modify an element does not by itself connote any priority, precedence, order of one claim element over another or the temporal order in which it is formed, but are used merely as labels to distinguish one claim element having a certain name from another element having the same name (but for use of the ordinal term) to distinguish the claim elements.

The disclosure provides a dye dispersion, a method for preparing the same, and dyeing method. the dye dispersion of the disclosure may include dyes derived from microbial production or chemical synthesis. The dyeing method of the disclosure departs from the conventional approach of needing to reduce dyes prior to the dyeing process, the dyeing method of the disclosure enables non-reductive dyeing of fibers. The dye characterized by small particle sizes enters the fabric since the fiber is swelled to increase pore size of the fabric, thereby completing the dyeing process. Accordingly, the disclosure provides a non-toxic, low-carbon, and environmentally adaptable indigo dye dispersion that can be used in the preparation of colored fibers, thereby reducing the environmental and human health risks associated with conventional reductive dyeing methods. According to embodiments of the disclosure, the dyeing method of the disclosure does not require the use of reducing agents or enzymes and can be performed under acidic conditions. The obtained colored fibers achieve high color strength value and wash fastness without the need for multiple dyeing cycles. Furthermore, the dyeing method is compatible with various indigo dyes, enabling fibers to be dyed in a range of hues, such as red, blue, and purple.

According to embodiments of the disclosure, the dye dispersion includes a dye with a low particle size distribution, a dispersant, and water. According to embodiments of the disclosure, the dye has a particle size distribution D90 of about 1 nm to 2.5 μm, such as about 2 nm, 5 nm, 10 nm, 20 nm, 25 nm, 50 nm, 75 nm, 100 nm, 200 nm, 500 nm, 750 nm, 1 μm, 1.5 μm, 2 μm, or 2.5 μm. When the particle size distribution D90 of the dye is too large, it becomes difficult for the dye particles to enter the fiber interior (such as polyester fiber or natural fiber) during the dyeing process, leading to reduced color strength value and wash fastness. Multiple dyeing cycles would then be required to achieve the desired color strength value and durability. Herein, the particle size distribution D90 indicates that 90% of the dye particles, by total volume, have a diameter smaller than the specified D90 value. According to embodiments of the disclosure, the particle size distribution D90 may be measured by dynamic light scattering (DLS).

According to embodiments of the disclosure, the amount of dye in the dye dispersion is 9-90 parts by weight (such as 10 parts by weight, 15 parts by weight, 20 parts by weight, 25 parts by weight, 30 parts by weight, 35 parts by weight, 40 parts by weight, 45 parts by weight, 50 parts by weight, 55 parts by weight, 60 parts by weight, 65 parts by weight, 70 parts by weight, 75 parts by weight, 80 parts by weight, or 85 parts by weight); the amount of dispersant is 0.5-20 parts by weight (such as 0.7 parts by weight, 1.0 parts by weight, 2 parts by weight, 3 parts by weight, 5 parts by weight, 10 parts by weight, or 15 parts by weight); and, the amount of water is 8-90 parts by weight (such as 10 parts by weight, 15 parts by weight, 20 parts by weight, 25 parts by weight, 30 parts by weight, 35 parts by weight, 40 parts by weight, 45 parts by weight, 50 parts by weight, 55 parts by weight, 60 parts by weight, 65 parts by weight, 70 parts by weight, 75 parts by weight, 80 parts by weight, or 85 parts by weight). When the components of dye dispersion fall within the above ranges, the dispersion is suitable for use in the dyeing method of the disclosure. The dyeing method enables non-reductive dyeing of fibers (such as polyester fiber or natural fiber) by utilizing high temperatures to swell fiber and increase pore size, allowing the dye to enter the fabric and complete the dyeing process.

According to embodiments of the disclosure, the dye has a structure represented by Formula (I), Formula (II), or Formula (III)

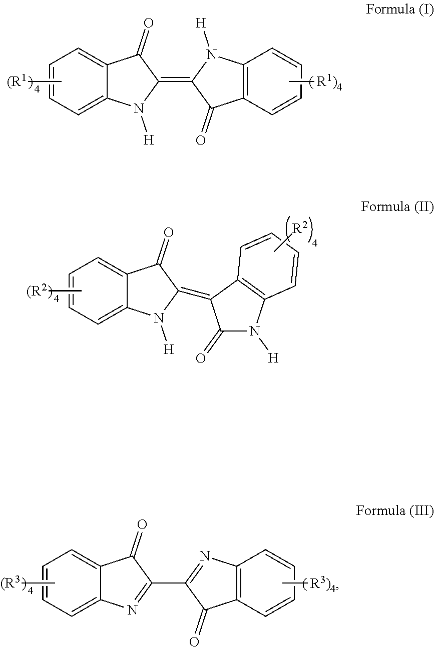

wherein R¹, R² and R³ are independently H, F, Cl, Br, or —SO₃N. For example, the dye may be

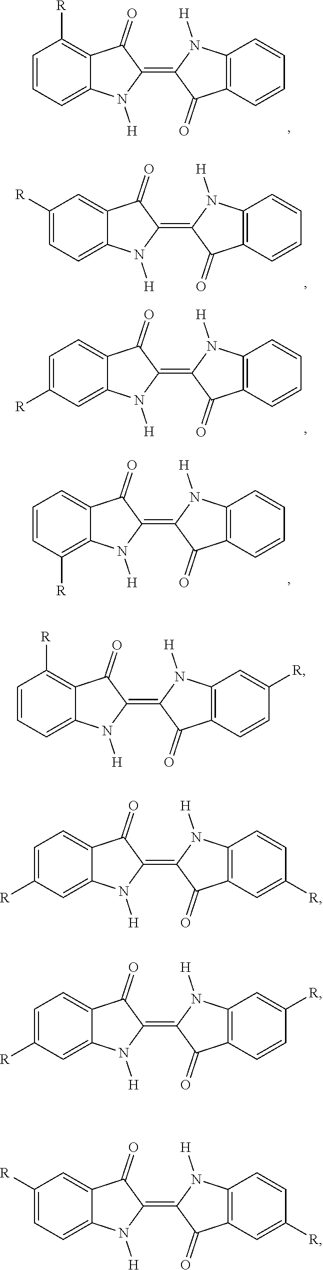

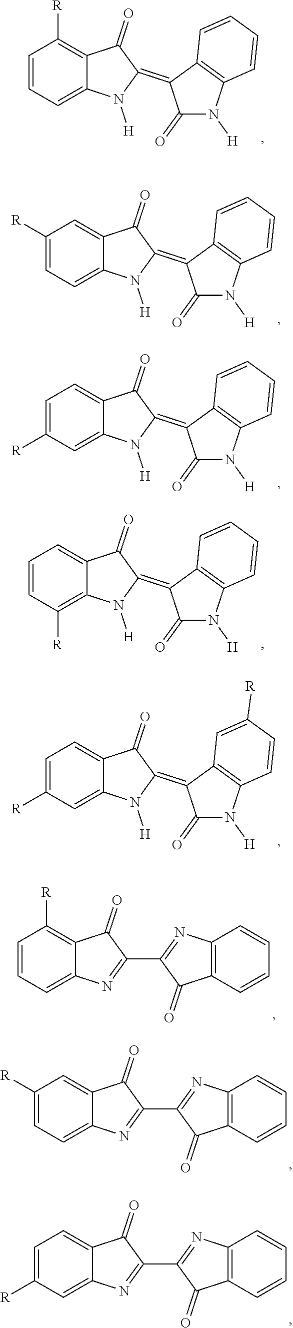

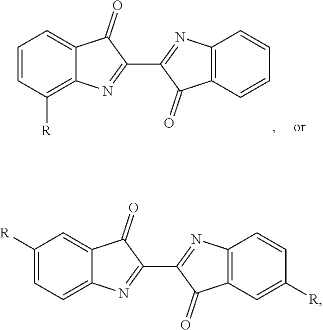

wherein R is independently F, Cl, Br, or —SO₃N. According to embodiments of the disclosure, the dye may be indigo, indirubin, 6′6-dibromoindigo, dehydroindigo, indigo carmine, 4-chloroindigo, 5-chloroindigo, 6-chloroindigo, 6-fluoroindigo, 6-bromoindigo, or a combination thereof. According to embodiments of the disclosure, the dye of the disclosure may be derived from microbial production, chemical synthesis, plant extraction, or a combination thereof. In some embodiments of the disclosure, the dye of the disclosure may be derived from microbial production or plant extraction. According to embodiments of the disclosure, the dye is not used in a reduced form and does not require a reduction process before use. According to embodiments of the disclosure, the dye of the disclosure does not need to be pre-treated with a protecting group.

According to embodiments of the disclosure, the dispersant may be a polyoxyethylene ether dispersant, sodium lignosulfonate dispersant, polyacrylic acid dispersant, polyurethane dispersant, or a combination thereof. The molecular weight of the dispersant is not specifically limited. For example, the weight-average molecular weight (Mw) of the dispersant in the disclosure may be about 1,000 g/mol to 300,000 g/mol, but the disclosure is not limited thereto.

According to embodiments of the disclosure, the dye dispersion of the disclosure does not include reducing agents or enzymes. Herein, the reducing agent or enzyme refers to those commonly used in conventional dyeing processes. According to embodiments of the disclosure, the dye dispersion of the disclosure consists of the dye of the disclosure, a dispersant, and water.

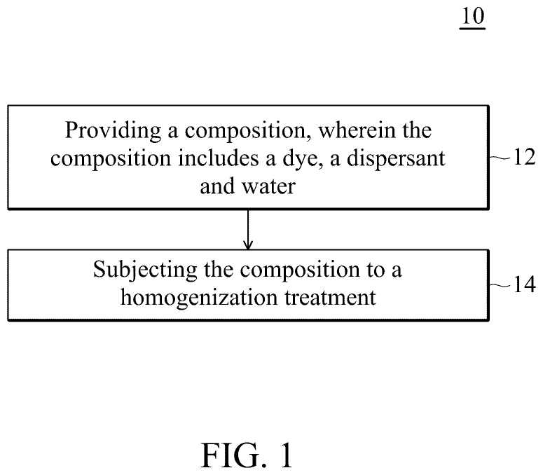

According to embodiments of the disclosure, the disclosure also provides a method for preparing dye dispersion to produce the aforementioned dye dispersion. As shown in FIG. 1, the method for preparing dye dispersion 10 may include the following steps. First, a composition is provided, wherein the composition includes a dye, a dispersant, and water (step 12), and the dye and dispersant are as defined above. Next, the composition is subjected to a homogenization treatment (step 14), obtaining the dye dispersion of the disclosure. In some embodiments, through the homogenization treatment, the dye in the dye dispersion may have a particle size distribution D90 ranging from 1 nm to 2.5 μm or 1 nm to 2 μm. As a result, when using the dye dispersion for dyeing polyester fiber, it can effectively enhance the color strength value and wash fastness of the colored polyester fiber. Therefore, a single dyeing process is sufficient to obtain a colored polyester fiber with high color strength value and wash fastness.

According to embodiments of the disclosure, the homogenization treatment may be ultrasonic vibration treatment or ball milling treatment. According to embodiments of the disclosure, the ultrasonic vibration treatment involves placing the composition in an ultrasonic vibrator, and oscillating at 15° C. to 50° C. for about 5 minutes to 120 minutes. The frequency and output power of the ultrasonic vibration treatment in the disclosure are not specifically limited and may be 10 KHz to 25 KHz, with an output power of 10 W to 150 W. According to embodiments of the disclosure, the ball milling treatment may be planetary ball milling or general ball milling. According to embodiments of the disclosure, the ball milling duration may be 5 minutes to 120 minutes, the milling speed may range from 100 rpm to 500 rpm, and the diameter of the milling beads may range from 50 μm to 1 mm.

According to embodiments of the disclosure, the amount of dye in the composition used for preparing the dye dispersion may be 9-90 parts by weight, the amount of dispersant may be 0.5-20 parts by weight, and the amount of water may be 8-90 parts by weight. According to embodiments of the disclosure, the composition does not include reducing agents or enzymes. According to embodiments of the disclosure, the composition used for preparing the dye dispersion consists of the dye of the disclosure, a dispersant, and water.

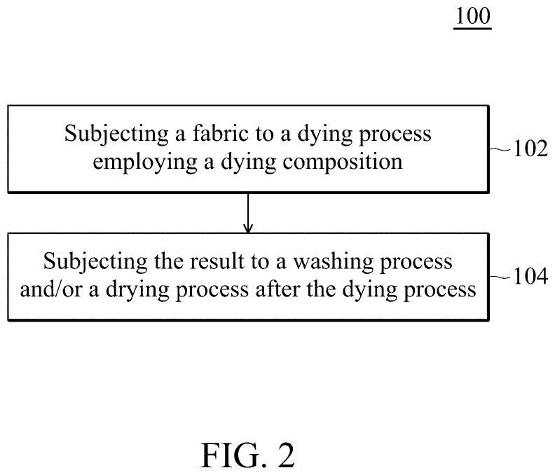

According to embodiments of the disclosure, the disclosure also provides a dyeing method. As shown in FIG. 2, the dyeing method 100 may include the following steps. A fabric (such as polyester fabric or natural fabric) is subjected to a dyeing process with a dye composition, obtaining a fabric (such as polyester or natural fabric) (step 102). In addition, after the dyeing process, the dyeing method 100 may further include subjecting the resulting product to a washing process (e.g., using soap and/or water) and/or a drying process (step 104). According to embodiments of the disclosure, the washing process and drying process are not specifically limited and may be conventional washing or drying processes used for fabrics after dyeing. According to embodiments of the disclosure, the dye composition includes the dye dispersion of the disclosure.

According to embodiments of the disclosure, the dyeing process in the dyeing method of the disclosure may be conducted at a temperature of 100° C. to 130° C., and the dyeing process duration is 30 minutes to 2 hours. If the process temperature is too low, the fibers (such as polyester fiber or natural fiber) do not swell easily, limiting the expansion of the gap between the fibers and making it difficult for the dye to enter the fiber interior. If the process temperature is too high, the dyeing process has high energy consumption and may cause the physical properties of the fabric to deteriorate.

According to embodiments of the disclosure, the dye concentration in the dye composition may be 0.1% to 15% o.w.f. (on weight the fabric), such as 0.5% o.w.f., 1% o.w.f, 2% o.w.f, 5% o.w.f, 7% o.w.f, 10% o.w.f, or 12% o.w.f. According to embodiments of the disclosure, the dye composition may be an aqueous solution and can include conventional additives used in the dyeing process. It should be noted that the additive does not include reducing agents or enzymes. According to embodiments of the disclosure, the pH value of the dye composition may be 4 to 7.

According to embodiments of the disclosure, the fabric may be polyester fabric or natural fabric. The polyester fabric may be polyethylene terephthalate, polyvinyl ester, or a combination thereof.

According to embodiments of the disclosure, the dye composition does not include reducing agents or enzymes. Namely, no reducing agent or enzyme is used in the dyeing method according to the disclosure (i.e., the dyeing process is conducted without the use of reducing agents or enzymes).

According to embodiments of the disclosure, the colored fabric (such as dyed polyester fabric or dyed natural fabric) may have a color strength value (K/S value) of 0.5 to 20, such as 1, 2, 3, 4, 5, 10, or 15. According to embodiments of the disclosure, the color strength value (K/S) of the colored fabric (such as dyed polyester fabric or dyed natural fabric) can be measured by a spectrophotometer (ilBasic Pro 2) and is represented by a numerical value in K/S. According to embodiments of the disclosure, the colored fabric may exhibit a wash fastness grade ranging from 3 to 5, as determined in accordance with AATCC 61.

Below, exemplary embodiments will be described in detail so as to be easily realized by a person having ordinary knowledge in the art. The inventive concept may be embodied in various forms without being limited to the exemplary embodiments set forth herein.

### Example 1

Pre-Treatment: 20 parts by weight of indigo (having a structure of

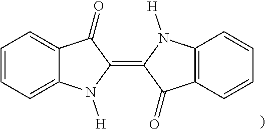 [SMILES: O=C1/C(=C2\Nc3ccccc3C2=O)Nc2ccccc21]

(chemically synthesized, commercially available from Sigma-Aldrich) (used as dye), 5 parts by weight of polyoxyethylene ether dispersant (commercially available from Chung Ya Industry Co., Ltd. with a trade number of Calever-140), and 75 parts by weight of water were mixed. Next, the result was subjected to a homogenization treatment, obtaining Dye dispersion (1), wherein the homogenization treatment involved placing the dye dispersion in an ultrasonic vibrator and oscillating at room temperature (25° C.) for about 10 minutes (with an oscillation frequency of 20 KHz and an output power of 15 W). Next, the particle size distribution D90 of the dye in Dye dispersion (1) was measured, obtaining a D90 of 125 nm. The particle size distribution D90 was measured by dynamic light scattering (DLS).

Dyeing/Washing Process: Dye dispersion (1), polyoxyethylene ether dispersant (commercially available from Chung Ya Industry Co., Ltd, with a trade number of Calever-140) and water were mixed, and then ammonium sulfate ((NH4)2SO4) (with a concentration of 1 g/L) was added. The pH value of the result was adjusted by acetic acid to obtain a dye composition (with a pH value of 5.5). 5 g of Polyester fabric (commercially available from Fang An Co., Ltd. with a trade number of Refined 75D/72+40D OP) was immersed in the dye composition (having 0.625 g of Dye dispersion (1)) with a dye concentration of 2.5% o.w.f. Next, 0.375 g of polyoxyethylene ether dispersant was added to achieve a dispersant concentration of 1% o.w.f in the dye composition. After dyeing at 130° C. for 60 minutes, the result was cooled down and the polyester fabric was isolated. Next, the polyester fabric was washed at 83° C. for 20 minutes (under the following conditions: sodium hydroxide (1 g/L), ammonium sulfate (2 g/L), 1.5% o.w.f. scouring agent (commercially available from Taiwan Nichiwa Chemical Industry Co., Ltd. with a trade number of ESKUDO RC-010), and 3.5% o.w.f. sodium dithionite (Na2S2O4)). After drying, Colored polyester fabric (1) was obtained.

Next, the brightness (L*), redness (a*), blueness (b*), color strength value (K/S), and wash fastness of Colored polyester fabric (1) were evaluated, and the results are shown in Table 1. The measurement method for L*, a*, and b* follows the Journal of The Textile Institute, Vol. 110, 2019, pages 81-88. The color strength value (K/S) of the colored polyester fabric was measured using a spectrophotometer (ilBasic Pro 2) and represented as a numerical value in K/S. The wash fastness evaluation follows AATCC 61 standards.

### Example 2

Example 2 was performed in the same manner as the method for preparing Colored polyester fabric (1) disclosed in Example 1, except that the dye concentration was increased from 2.5% o.w.f. to 5% o.w.f. (the particle size distribution D90 of the dye in Dye dispersion (1) was 125 nm), obtaining Colored polyester fabric (2). Next, the brightness (L*), redness (a*), blueness (b*), color strength value (K/S), and wash fastness of colored polyester fabric (2) were evaluated, and the results are shown in Table 1.

### Example 3

Example 3 was performed in the same manner as the method for preparing Dye dispersion (1) disclosed in Example 1, except that indigo was replaced with indirubin (having a structure of

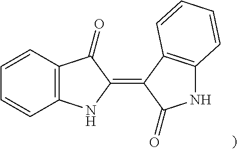 [SMILES: O=C1Nc2ccccc2/C1=C1/Nc2ccccc2C1=O]

(chemically synthesized, commercially available from Sigma-Aldrich), obtaining Dye dispersion (2). The particle size distribution D90 of the dye in Dye dispersion (2) was 130 nm.

Next, the preparation method of Colored polyester fabric (1) as described in Example 1 was performed, except that Dye dispersion (1) was replaced with Dye dispersion (2), obtaining Colored polyester fabric (3). Next, the brightness (L*), redness (a*), blueness (b*), color strength value (K/S), and wash fastness of Colored polyester fabric (3) were evaluated, and the results are shown in Table 1.

TABLE 1

| | Example 1 | Example 2 | Example 3 |
|---|---|---|---|
| | Dye dispersion | Dye dispersion | Dye dispersion |
| | (1): indigo | (1): indigo | (2): indirubin |
| the amount of | 5 | 5 | 5 |
| dispersant in the | | | |
| dye | | | |
| dispersion(parts | | | |
| by weight) | | | |
| dye concentration | 2.5 | 5 | 2.5 |
| (% o.w.f) | | | |
| color strength | 1.2 | 5.55 | 0.81 |
| value | | | |
| L* | 78.6 | 36.54 | 82.5 |
| a* | −5.5 | −0.46 | 49.5 |
| b* | −17.4 | −9.31 | −9.5 |
| wash fastness | 4-5 | 4-5 | 4-5 |

As shown in Table 1, due to the dyeing method of the disclosure, dye with a smaller particle size can enter fibers and complete the dyeing process of polyester fabric without the addition of a reducing agent or enzyme. The chemically sourced indigo dye shows an increase in color strength value as dye concentration increases. The colored polyester fabrics dyed with indigo and indirubin exhibit blue and red hues, respectively, and have high wash fastness.

### Comparative Example 1

Comparative Example 1 was performed in the same manner as the method for preparing Dye dispersion (1) disclosed in Example 1, except that no homogenization treatment was performed, obtaining Dye dispersion (3). The particle size distribution D90 of the dye in Dye dispersion (3) was measured, obtaining a D90 of 3 μm.

Next, the preparation method of Colored polyester fabric (1) as described in Example 1 was performed, except that Dye dispersion (1) was replaced with Dye dispersion (3), obtaining Colored polyester fabric (4). Next, the brightness (L*), redness (a*), blueness (b*), color strength value (K/S), and wash fastness of Colored polyester fabric (4) were evaluated, and the results are shown in Table 2.

### Comparative Example 2

Pre-Treatment: No.

Dyeing/Washing Process: 20 parts by weight of indigo (chemically synthesized) (used as dye), and 80 parts by weight of water were mixed, obtaining Dye dispersion (4). Next, the particle size distribution D90 of the dye in Dye dispersion (4) was measured, obtaining a D90 of 5 μm.

Next, the preparation method of Colored polyester fabric (1) as described in Example 1 was performed, except that Dye dispersion (1) was replaced with Dye dispersion (4), obtaining Colored polyester fabric (5). Next, the brightness (L*), redness (a*), blueness (b*), color strength value (K/S), and wash fastness of Colored polyester fabric (5) were evaluated, and the results are shown in Table 2.

TABLE 2

| | | Comparative | Comparative |
|---|---|---|---|
| | Example 1 | Example 1 | Example 2 |
| | Dye dispersion | Dye dispersion | Dye dispersion |
| | (1): indigo | (3): indigo | (4): indigo |
| the amount of | 5 | 5 | 0 |
| dispersant in the dye | | | |
| dispersion(parts by | | | |
| weight) | | | |
| homogenization | Yes | No | No |
| treatment | | | |
| dye D90 | 125 nm | 3 μm | 5 μm |
| dye concentration | 2.5 | 2.5 | 2.5 |
| (% o.w.f) | | | |
| color strength value | 1.2 | 0.8 | 0.81 |
| L* | 78.6 | 82.6 | 82.8 |
| a* | −5.5 | −3.5 | −3.2 |
| b* | −17.4 | −15.1 | −15.5 |
| wash fastness | 4-5 | 4 | 4 |

As shown in Table 2, in comparison to Example 1, the colored polyester fabrics dyed with dye dispersions without homogenization treatment (Comparative Examples 1 and 2) exhibits lower color strength values. In addition, the color strength values of Comparative Examples 1 and 2 are similar, indicating that even with the addition of dispersant but without homogenization treatment, the dye particle size remains large, leading to poor dyeing color strength.

### Example 4

Pre-Treatment: 20 parts by weight of indigo (having a structure of

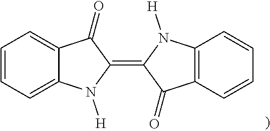 [SMILES: O=C1/C(=C2\Nc3ccccc3C2=O)Nc2ccccc21]

(microbial production) (used as dye), 5 parts by weight of polyoxyethylene ether dispersant (commercially available from Chung Ya Industry Co., Ltd. with a trade number of Calever-140), and 75 parts by weight of water were mixed. Next, the result was subjected to a homogenization treatment, obtaining Dye dispersion (5), wherein the homogenization treatment involved placing the dye dispersion in an ultrasonic vibrator and oscillating at room temperature (25° C.) for about 10 minutes (with an oscillation frequency of 20 KHz and an output power of 15 W). Next, the particle size distribution D90 of the dye in Dye dispersion (5) was measured, obtaining a D90 of 131 nm.

Dyeing/Washing Process: Dye dispersion (5), polyoxyethylene ether dispersant (commercially available from Chung Ya Industry Co., Ltd. with a trade number of Calever-140) and water were mixed, and then ammonium sulfate ((NH₄)₂SO₄) (with a concentration of 1 g/L) was added to adjust the pH value, obtaining the dye composition (with a pH value of 5.5), wherein the concentration of polyoxyethylene ether dispersant was 1% o.w.f Next, the polyester fabric (commercially available from Fang An Co., Ltd. with a trade number of Refined 75D/72+40D OP) was immersed in the dye composition (with a dye concentration of 2.5% o.w.f). After dyeing at 130° C. for 60 minutes, the result was cooled down and the polyester fabric was isolated. Next, the polyester fabric was washed at 83° C. for 20 minutes (under the following conditions: sodium hydroxide (1 g/L), ammonium sulfate (2 g/L), 1.5% o.w.f. scouring agent (commercially available from Taiwan Nichiwa Chemical Industry Co., Ltd. with a trade number of ESKUDO RC-010), and 3.5% o.w.f. sodium dithionite (Na₂S₂O₄)). After drying, Colored polyester fabric (6) was obtained.

Next, the brightness (L*), redness (a*), blueness (b*), color strength value (K/S), and wash fastness of Colored polyester fabric (6) were evaluated, and the results are shown in Table 3.

### Example 5

Example 5 was performed in the same manner as the method for preparing Colored polyester fabric (6) disclosed in Example 4, except that the dye concentration was increased from 2.5% o.w.f. to 5% o.w.f., obtaining Dye dispersion (7). Next, the brightness (L*), redness (a*), blueness (b*), color strength value (K/S), and wash fastness of Colored polyester fabric (7) were evaluated, and the results are shown in Table 3.

### Example 6

Example 6 was performed in the same manner as the method for preparing Colored polyester fabric (6) disclosed in Example 4, except that the dye concentration was increased from 2.5% o.w.f. to 7.5% o.w.f., obtaining Dye dispersion (8). Next, the brightness (L*), redness (a*), blueness (b*), color strength value (K/S), and wash fastness of Colored polyester fabric (8) were evaluated, and the results are shown in Table 3.

TABLE 3

| | Example 4 | Example 5 | Example 6 |
|---|---|---|---|
| | Dye | Dye | Dye |
| | dispersion (5) | dispersion (5) | dispersion (5) |
| the amount of | 5 | 5 | 5 |
| dispersant in | | | |
| Pre-Treatment | | | |
| (parts by | | | |
| weight) | | | |
| dye | 2.5 | 5 | 7.5 |
| concentration | | | |
| (% o.w.f) | | | |
| color strength | 0.93 | 6.02 | 16.81 |
| value | | | |
| L* | 80.6 | 35.33 | 19.97 |
| a* | −4.5 | −0.33 | 3.02 |
| b* | −17.6 | −9.35 | −5.83 |
| wash | 4-5 | 4-5 | 4-5 |
| fastness | | | |

As shown in Table 3, the dyeing method of the disclosure is also applicable to microbial-produced indigo dye. After processing for dyeing, the color strength value increases with the dye concentration. Without adding reducing agents or enzymes to the dye composition, dye particles with a smaller particle size can penetrate the fiber interior, enabling the dyeing of polyester fabric.

### Comparative Example 3

Comparative Example 3 was performed in the same manner as the method for preparing Dye dispersion (5) disclosed in Example 4, except that no homogenization treatment was performed, obtaining Dye dispersion (6). Next, the particle size distribution D90 of the dye in Dye dispersion (6) was measured, obtaining a D90 of 3 μm.

Next, the preparation method of Colored polyester fabric (6) as described in Example 4 was performed, except that Dye dispersion (5) was replaced with Dye dispersion (6), obtaining Colored polyester fabric (9). Next, the brightness (L*), redness (a*), blueness (b*), color strength value (K/S), and wash fastness of Colored polyester fabric (9) were evaluated, and the results are shown in Table 4.

### Comparative Example 4

Pre-Treatment: No.

Dyeing/Washing Process: 20 parts by weight of indigo (microbial production) used as the dye and 80 parts by weight of water were mixed, obtaining Dye dispersion (7). Next, the particle size distribution D90 of the dye in Dye dispersion (7) was measured, obtaining a D90 of 8 μm.

Next, the preparation method of Colored polyester fabric (6) as described in Example 4 was performed, except that Dye dispersion (5) was replaced with Dye dispersion (7), obtaining Colored polyester fabric (10). Next, the brightness (L*), redness (a*), blueness (b*), color strength value (K/S), and wash fastness of Colored polyester fabric (10) were evaluated, and the results are shown in Table 4.

TABLE 4

| | | Comparative | Comparative |
|---|---|---|---|
| | Example 4 | Example 3 | Example 4 |
| | Dye dispersion | Dye dispersion | Dye dispersion |
| | (5) | (6) | (7) |
| the amount of | 5 | 5 | 0 |
| dispersant in the | | | |
| dye | | | |
| dispersion(parts | | | |
| by weight) | | | |
| homogenization | Yes | No | No |
| treatment | | | |
| dye D90 | 125 nm | 3 μm | 5 μm |
| dye concentration | 2.5 | 2.5 | 2.5 |
| (% o.w.f) | | | |
| color strength | 0.93 | 0.8 | 0.79 |
| value | | | |
| L* | 80.6 | 81.5 | 83 |
| a* | −4.5 | −3.5 | −3.1 |
| b* | −17.6 | −16.1 | −15.6 |
| wash fastness | 4-5 | 4 | 4 |

As shown in Table 4, in comparison with Example 4, the dye dispersions without homogenization treatment (i.e., Comparative Examples 3 and 4) had larger dye particle sizes, leading to lower color strength values in the dyed polyester fabric. Additionally, even with the addition of dispersants to the dye dispersion, the lack of homogenization treatment still failed to reduce the dye particle size, resulting in poor color strength values in the colored fabric.

### Example 7

Pre-Treatment: 20 parts by weight of dye (including indigo and indirubin in a ratio of 99:1, both derived from microbial production), 5 parts by weight of polyoxyethylene ether dispersant (commercially available from Chung Ya Industry Co., Ltd. with a trade number of Calever-140), and 75 parts by weight of water were mixed. Next, the result was subjected to a homogenization treatment, obtaining Dye dispersion (8), wherein the homogenization treatment involved placing the dye dispersion in an ultrasonic vibrator and oscillating at room temperature (25° C.) for about 10 minutes (with an oscillation frequency of 20 KHz and an output power of 15 W).

Dyeing/Washing Process: Dye dispersion (8), polyoxyethylene ether dispersant (commercially available from Chung Ya Industry Co., Ltd. with a trade number of Calever-140) and water were mixed, and then ammonium sulfate ((NH₄)₂SO₄) (with a concentration of 1 g/L) was added to adjust the pH value, obtaining the dye composition (with a pH value of 5.5), wherein the concentration of polyoxyethylene ether dispersant was 1% o.w.f. Next, the polyester fabric (commercially available from Fang An Co., Ltd. with a trade number of Refined 75D/72+40D OP) was immersed in the dye composition (with a dye concentration of 5% o.w.f). After dyeing at 130° C. for 60 minutes, the result was cooled down and the polyester fabric was isolated. Next, the polyester fabric was washed at 83° C. for 20 minutes (under the following conditions: sodium hydroxide (1 g/L), ammonium sulfate (2 g/L), 1.5% o.w.f. scouring agent (commercially available from Taiwan Nichiwa Chemical Industry Co., Ltd. with a trade number of ESKUDO RC-010), and 3.5% o.w.f. sodium dithionite (Na₂S₂O₄)). After drying, Colored polyester fabric (11) was obtained.

Next, the brightness (L*), redness (a*), blueness (b*), color strength value (K/S), and wash fastness of Colored polyester fabric (11) were evaluated, and the results are shown in Table 5.

### Example 8

Example 8 was performed in the same manner as the method for preparing Dye dispersion (8) disclosed in Example 7, except that the ratio of indigo to indirubin was adjusted from 99:1 to 1:60, obtaining Dye dispersion (9).

Next, the preparation method of Colored polyester fabric (11) as described in Example 7 was performed, except that Dye dispersion (8) was replaced with Dye dispersion (9), obtaining Colored polyester fabric (12). Next, the brightness (L*), redness (a*), blueness (b*), color strength value (K/S), and wash fastness of Colored polyester fabric (12) were evaluated, and the results are shown in Table 5.

### Example 9

Example 9 was performed in the same manner as the method for preparing Dye dispersion (9) disclosed in Example 7, except that the dye (mixture of indigo to indirubin) was replaced with 6,6′-dibromoindigo (having a structure of

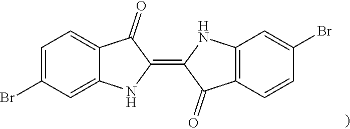 [SMILES: O=C1/C(=C2\Nc3cc(Br)ccc3C2=O)Nc2cc(Br)ccc21]

(microbial production), obtaining Dye dispersion (10).

Next, the preparation method of Colored polyester fabric (11) as described in Example 7 was performed, except that Dye dispersion (8) was replaced with Dye dispersion (10) (with a dye concentration of 2.5% o.w.f), obtaining Colored polyester fabric (13). Next, the brightness (L*), redness (a*), blueness (b*), color strength value (K/S), and wash fastness of Colored polyester fabric (13) were evaluated, and the results are shown in Table 5.

TABLE 5

| | Example 7 | Example 8 | Example 9 |
|---|---|---|---|
| | Dye | Dye | Dye |
| | dispersion | dispersion | dispersion |
| | (8) | (9) | (10) |
| dye | indigo and | indigo and | 6,6′- |
| | indirubin | indirubin | dibromoindigo |
| | (99:1) | (1:60) | |
| dye | 5 | 5 | 2.5 |
| concentration | | | |
| (% o.w.f) | | | |
| color strength | 3.69 | 3.5 | 2.6 |
| value | | | |
| L* | 41.3 | 35 | 50.31 |
| a* | −3.91 | 42.8 | 30.6 |
| b* | −16.8 | −18.3 | −5.4 |
| wash | 3-4 | 3-4 | 3-4 |
| fastness | | | |

As shown in Table 5, after the homogenization treatment, the proportion of microbial dye can be adjusted to obtain colored polyester fabric with various purple hues. In addition, the dyeing method of the disclosure is also applicable to other indigo dyes (such as 6,6′-dibromoindigo), resulting in colored polyester fabric with good color strength values and washing fastness.

Accordingly, due to the dyeing method of the disclosure, the conventional requirement of reducing the dye before dyeing can be eliminated. Non-reductive dyeing of polyester fiber can be achieved by utilizing high temperature to swell fiber and increase pore size, allowing the dye with small particle size to enter the fabric and complete the dyeing process. The colored polyester fabric exhibits high color strength values and washing fastness without the need for multiple dyeing cycles. Additionally, the method is suitable for dye combinations, forming colored polyester fibers with various hues (such as red, blue, and purple).

It will be clear that various modifications and variations can be made to the disclosed methods and materials. It is intended that the specification and examples be considered as exemplary only, with the true scope of the disclosure being indicated by the following claims and their equivalents.

What is claimed is:

1. A dye dispersion, comprising:
a dye, wherein the dye has a particle size distribution D90 of 1 nm to 2.5 μm, and the dye has a structure represented by Formula (I), Formula (II), or Formula (III) 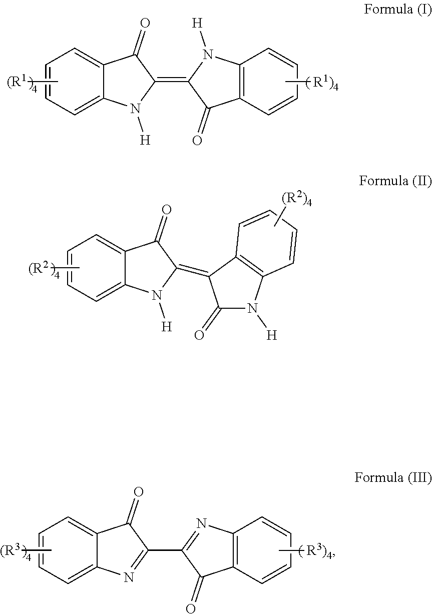
wherein R¹, R² and R³ are independently H, F, Cl, Br, or —SO₃Na;
a dispersant; and
water.

2. The dye dispersion as claimed in claim 1, wherein the dye is 9-90 parts by weight, the dispersant is 0.5-20 parts by weight, and water is 8-90 parts by weight, wherein a total weight of the dye, dispersant and water is 100 parts by weight.

3. The dye dispersion as claimed in claim 1, wherein the dye is indigo, indirubin, 6′6-dibromoindigo, dehydroindigo, indigo carmine, 4-chloroindigo, 5-chloroindigo, 6-chloroindigo, 6-fluoroindigo, 6-bromoindigo, or a combination thereof.

4. The dye dispersion as claimed in claim 1, wherein the dye is derived from microbial production, chemical synthesis, plant extraction, or a combination thereof.

5. The dye dispersion as claimed in claim 1, wherein the dispersant is a polyoxyethylene ether dispersant, sodium lignosulfonate dispersant, acrylic acid dispersant, polyurethane dispersant, or a combination thereof.

6. A method for preparing dye dispersion, comprising:
providing a composition, wherein the composition comprises a dye, a dispersant and water, wherein the dye has a structure represented by Formula (I), Formula (II) or Formula (III) 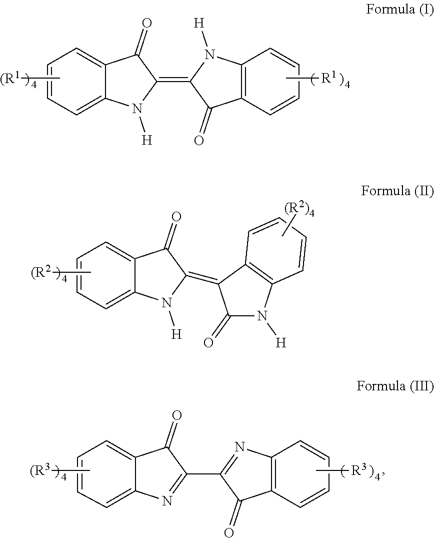
wherein R¹, R² and R³ are independently H, F, Cl, Br, or —SO₃Na; and
subjecting the composition to a homogenization treatment, obtaining the dye dispersion as claimed in claim 1.

7. The method for preparing dye dispersion as claimed in claim 6, wherein the homogenization treatment is ultrasonic vibration treatment or ball milling treatment.

8. A dyeing method, comprising:
subjecting a fabric to a dyeing process with a dye composition to obtain a colored fabric, wherein the dye composition comprises the dye dispersion as claimed in claim 1.

9. The dyeing method as claimed in claim 8, wherein the fabric is a polyester fabric or a natural fabric.

10. The dyeing method as claimed in claim 8, wherein a dye concentration in the dye composition is 0.1% to 15% o.w.f.

11. The dyeing method as claimed in claim 8, wherein the dye composition is an aqueous solution.

12. The dyeing method as claimed in claim 8, wherein the dye composition has a pH value of 4 to 7.

13. The dyeing method as claimed in claim 9, wherein the polyester fabric is polyethylene terephthalate, polyvinyl ester, or a combination thereof.

14. The dyeing method as claimed in claim 8, wherein the dyeing process is conducted at a temperature of 100° C. to 130° C.

15. The dyeing method as claimed in claim 8, wherein the dyeing process has a process duration of 30 minutes to 2 hours.

16. The dyeing method as claimed in claim 8, wherein the dye composition does not comprise a reducing agent or enzyme.

17. The dyeing method as claimed in claim 8, wherein the colored fabric has a color strength value (K/S) of 0.5 to 20.

18. The dyeing method as claimed in claim 8, wherein the colored fabric has a wash fastness of 3 to 5, as measured in accordance with AATCC 61.
